(19) United States
(12) Patent Application Publication
(10) Pub. No.: US 2026/0290162 A1
(43) Pub. Date: Sep. 24, 2026

(54) Method and System for Coordinating Autonomous Vehicles in at Least One Traffic Region

(71) Applicant: Bayerische Motoren Werke Aktiengesellschaft, Muenchen (DE)

(72) Inventors: Georg FLOERCHINGER, Sinzing (DE); Lukas HEINEN, Greensville, SC (US)

(21) Appl. No.: 19/100,615

(22) PCT Filed: Sep. 27, 2023
(86) PCT No.: PCT/EP2023/076713

§ 371 Date: Feb. 3, 2025

(30) Foreign Application Priority Data
Oct. 25, 2022 (DE) 10 2022 128 153.1

(51) Int. Cl. G08G 1/0967; B60W 60/00

(52) U.S. Cl. CPC G08G 1/096725; B60W 60/0011; G08G 1/096775; B60W 2556/45

(57) ABSTRACT

The present disclosure relates to a method and a system for coordinating autonomous vehicles in at least one traffic region, comprising the steps of: a central electronic computing device receiving a first trajectory planned by a first of the autonomous vehicles; the central electronic computing device receiving a second trajectory planned by a second of the autonomous vehicles; determining an area requirement of each autonomous vehicle along its planned trajectory; when the central computing device determines that the two area requirements with the planned trajectories at least partly overlap in the at least one traffic region: the central electronic computing device prioritizing the first autonomous vehicle or the second autonomous vehicle; and issuing a travel permission (by means of a signal).

### BACKGROUND AND SUMMARY

The invention relates to a method and a system according to the independent claims, which are used to coordinate autonomous vehicles in at least one traffic region.

EP 2 911 926 B1 discloses a method for coordinating the operation of motor vehicles driving in a fully automated manner. DE 11 2019 000 279 T5 discloses a control of autonomous vehicles on the basis of safe arrival times. Finally, DE 10 2015 007 531 B3 discloses a method for traffic control in a parking environment.

Furthermore, for example, driverless transport vehicles (abbreviated DTV) are known from the general prior art, which are used in particular in the context of a production of products, for example automobile construction, in order to transport transported goods—for example components—to produce the products.

Such driverless transport vehicles form an autonomously driving vehicle. In addition, autonomously driving vehicles will also be encountered more and more frequently in general road traffic.

An object of the present invention is to provide a method and a system for coordinating autonomous vehicles in at least one traffic region, by which a particularly advantageous traffic flow of the autonomous vehicles can be implemented at least in the at least one traffic region.

This object is achieved according to the invention by a method and a system having features according to the independent claims. Advantageous embodiments and refinements of the invention are specified in the dependent claims and also in the description and in the drawings.

A first aspect of one form of the invention relates to a method for coordinating autonomous vehicles in or at least one traffic region, for example an intersection region. A form of the method according to the invention may comprises the following steps:

In a first step, a first trajectory planned by a first of the autonomous vehicles is received by means of a central electronic computing device.

In a second step, a second trajectory planned by a second of the autonomous vehicles is received by means of the central electronic computing device.

In a third step, a first area requirement of the first autonomous vehicle along its first planned trajectory and a second area requirement of the second autonomous vehicle along its second planned trajectory are each in particular determined by the central electronic computing device.

In a fourth step, if it is ascertained by means of the central computing device that the two area requirements at least partially overlap with the planned trajectories in the at least one traffic region, the first autonomous vehicle or the second autonomous vehicle is prioritized by the central electronic computing device. Furthermore, an approval to travel, i.e. at least to drive into or in particular to drive through, the traffic region is granted for the prioritized autonomous vehicle. Furthermore, in particular an approval of the non-prioritized vehicle does not take place and therefore its planned trajectory has a chronological interruption due to the non-approval to travel the traffic region.

The autonomous vehicle can in particular be a tugger train or a smart robot platform in a production region or alternatively a motor vehicle, such as an autonomously driving passenger vehicle. Preferably, the respective autonomous vehicle is, for example, a floor-based driverless transport vehicle which drives along the respective trajectory and in this case, for example, along a floor, i.e. on a floor. In particular, the respective autonomous vehicle is in principle movable freely in space or freely along the floor.

The respective reception of the trajectory can be understood as a respective registration, in particular login, of the vehicle at the central system, which is formed at least by the central electronic computing device.

When reference is made hereinafter to the electronic computing device, this is to be understood, if not indicated otherwise, as the central electronic computing device. This central system or the central electronic computing device is to be understood here in particular as the central traffic controller, in particular for the traffic region. The numbering of the steps does not necessarily indicate a corresponding chronological sequence of the steps, but rather is used in particular for uniquely addressing the steps.

In other words, in the first step of the method, a first trajectory of the first vehicle calculated by a first one of the autonomous vehicles itself or at least specified thereby is received by means of the electronic computing device. The electronic computing device thus receives the first trajectory of the first vehicle, wherein the first autonomous vehicle calculates the trajectory itself or at least specifies it. For this purpose, for example, the first autonomous vehicle comprises a separate first mobile electronic computing device, by means of which the first vehicle calculates the first trajectory. If the first autonomous or therefore driverless vehicle drives along the first trajectory, the first mobile computing device of the first vehicle can be moved relative to the central electronic computing device. These statements apply analogously to the second step of the method or the second trajectory and in particular the second autonomous vehicle.

The second vehicle can in particular have a second mobile electronic computing device, which can also move relative to the central computing device. The mobile electronic computing devices are therefore separate individual computing devices, which can be provided additionally to the central electronic computing device and are formed separately therefrom. In particular, however, the respective electronic computing device has a communication module or is connected to a communication device, so that at least the respective electronic computing devices each communicate with the central electronic computing device, i.e. can exchange data, for example, which describe the trajectory, for example. The communication device is designed here in particular such that a wireless or in particular cordless transmission of data can be provided between individual computing devices.

In the third step of the method, in other words a respective area requirement or space requirement for the respective vehicle is ascertained by means of the central electronic computing device, wherein the respective area requirement can be understood, for example, to mean that a first region is ascertained along the first trajectory, wherein, for example, the first autonomous vehicle would move or would be moved through the first region on its path along the first trajectory, and in the first region, if the first autonomous vehicle drove or were driven along the first trajectory, it would occupy space or in particular floor space in the region at a specific point in time according to its footprint. Corresponding statements on the first area requirement apply analogously to the second area requirement. The respective vehicle thus would occupy or occupies the respective area requirement or the associated region if it drove or were driven along the respective trajectory. Additionally or alternatively, the area requirement can also be viewed, for example, as a time-dependent area corridor, through which the respective autonomous vehicle would drive or would be driven if it drove or were driven along its respective trajectory.

In other words, it is therefore ascertained in the fourth step how the area requirements, in particular, for example, in the form of regions or driving area, mutually at least partially overlap, i.e. intersect and/or at least partially lie one inside another. A criterion is created on the basis of this overlap, which enables the prioritization of one of the vehicles, which therefore then receives the approval to drive into or through the traffic region on the basis of its registration. The approval takes place via the respective communication devices of the electronic computing device of the autonomous vehicles. If still other road users, such as manually guided passenger vehicles, are also located in or at the traffic region, the approval can take place, for example, by means of a signal, for example a light signal in the form of a traffic signal at the traffic region.

By means of the invention, a particularly advantageous traffic flow can be implemented, for example, in the form of a high throughput of vehicles at least in the at least one traffic region, which can be, for example, an intersection, an entrance, a fire protection door, a barrier, or the like. In particular, blocks or congestion layers of the autonomous vehicles, also referred to as deadlocks, can be avoided by the invention if, for example, driverless transport vehicles are used as autonomous vehicles in transport facilities, which have bottlenecks, one-way roads, or the like.

In an advantageous embodiment of the invention, the prioritization of the first autonomous vehicle or the second autonomous vehicle, thus the autonomous vehicle which receives the approval to travel, takes place on the basis of a specified set of rules stored in the central electronic computing device. In other words, rules or instructions are stored in the electronic computing device, on the basis of which the central electronic computing device can select which of the at least two autonomous vehicles, thus the first autonomous vehicle or the second autonomous vehicle, is prioritized for the approval to drive into or drive through the traffic region. One rule can be, for example, that the vehicle can only drive in when it does not obstruct any other vehicle. A further rule can represent, for example, the arrival time as a function of the respective planned trajectory at the traffic region. A further set of rules can be based, for example, on conventional traffic rules. If the traffic region is designed as an intersection, for example, a simple right before left guideline can apply for driving into the intersection region. This gives the method the advantage of obtaining a specified and in particular fair or required prioritization of the vehicles in an efficient manner.

In a further advantageous embodiment of the invention, the approval to travel is carried out by a signal, which is transmitted to the prioritized vehicle and/or by a traffic element, such as a traffic signal, of the traffic region. In other words, a signal is generated or provided by the central electronic computing device, which can be received by the prioritized autonomous vehicle and/or even by the nonprioritized autonomous vehicle, in order to enable the prioritized vehicle to drive into the traffic region.

In this case, the traffic element is in particular a device assigned to the traffic region which can take influence on a traffic flow therein. The traffic element can thus be, for example, a barrier, a traffic signal, a gate, or the like. The traffic element has, for example, a separate electronic computing device or at least one control device here, which can receive a signal of the central electronic computing device or can output a further signal for the autonomous vehicles, for example, by means of a communication device. The advantage thus results that the approval can take place particularly advantageously.

In a further advantageous embodiment of the invention, if it is ascertained by means of the central electronic computing device that the prioritized autonomous vehicle is driven along its planned trajectory such that an overlap of the area requirements does not take place, an approval to travel the traffic region is granted by the central electronic computing device to the further autonomous vehicle. In other words, it is checked whether the area requirement of the prioritized vehicle when traveling the traffic region permits an approval to be output for the further or the not yet prioritized autonomous vehicle at least from a specific point in time, without an overlap of the regions occurring. It can thus be that its length is known for each vehicle, for example, as a function of the speed, the area corridor is occupied such that the approval to the further autonomous vehicle can take place. The advantage thus results that the traffic throughput in the traffic region can be particularly high in a particularly advantageous manner.

In a further advantageous embodiment, at least one surrounding region adjoining the traffic region and in particular, in the case of at least two traffic regions, located between the two traffic regions, is taken into consideration in the approval. In other words, it is taken into consideration for the prioritization or for the approval, in particular in the case of multiple autonomous vehicles, for example, which area the surrounding region has. The surrounding region can comprise a road or a path here, which in particular has a specific length, and which adjoins, for example, a traffic region designed as an intersection. The approvals then take place, for example, as long as an area or an area requirement in the surrounding region is greater than the area requirement of all vehicles driving through the traffic region in the surrounding region due to the respective approval. The advantage thus results that a traffic flow can be provided by the method in a particularly advantageous manner.

In a further advantageous embodiment, a status of a traffic element or of the traffic element of the traffic region is ascertained and the approval additionally takes place as a function of this ascertained status. In other words, the status of the traffic element is detected by the central electronic computing device. If the traffic element is, for example, a barrier, it is ascertained whether it is currently closed or open. The approval to travel the traffic region now takes place as a function of this status. If the barrier is closed and this forms at least a part of the traffic region, currently no approval can take place for the prioritized autonomous vehicle. The advantage thus results that a travel of the respective traffic region can be enabled in a particularly advantageous manner.

In a further advantageous embodiment, if a further trajectory planned by a further one of the autonomous vehicles is received by means of the central electronic computing device, one of the previously non-considered autonomous vehicles is prioritized on the basis of a time interval in the prioritization. In other words, for example, if multiple autonomous vehicles wish to drive into the traffic region and this is chronologically not possible, a prioritization of a previously non-prioritized vehicle will take place on the basis of a time interval, which in particular describes a waiting time. The so-called first-in-first-out principle can be applied here, for example. The advantage thus results that it can be ensured that each autonomous vehicle is enabled after a certain time to travel or traverse the traffic region, even if it could not easily be prioritized, for example, on the basis of the set of rules.

In a further advantageous embodiment of the invention, if it is ascertained by means of the central electronic computing device that the first trajectory and the second trajectory at least partially coincide in the traffic region, but without an overlap of the area requirements, an approval is granted to the first and the second vehicle. In other words, it is checked or ascertained by the central electronic computing device whether, in the case of autonomous vehicles which are in particular driving the same direction or at least wish to drive, for example, in the same direction through the traffic region, a chronological cycling of the trajectories is possible such that a simultaneous approval for travel is enabled. Therefore, for example, a convoy can be implemented or an approval to travel can take place at least partially simultaneously for multiple vehicles of a convoy. The advantage thus results that the method can be used particularly advantageously for a particularly large traffic flow.

In a further advantageous embodiment of the invention, if a nonautonomous road user or a road user which is not connected to the central electronic computing device is detected by a sensor device of at least one of the autonomous vehicles and a correction thus takes place of the associated trajectory of the autonomous vehicle which has detected the road user, the prioritization or the approval is updated. In other words, the autonomous vehicle can be equipped with sensors, in particular surroundings sensors, which detect the surroundings of the vehicle, so that it can independently perceive or detect other road users, for example a motor vehicle. If a motor vehicle unknown to the system or the electronic computing device is detected, the autonomous vehicle which has detected the road user, in particular if its detection has a direct influence on the planned trajectory, can carry out a change of this trajectory. This change of the trajectory is used in an update of the method in order to change the prioritization or the approval if necessary. The advantage thus results that the method can be used particularly advantageously at hybrid traffic regions which serve autonomous and manual traffic simultaneously.

A second aspect of some forms of the invention relates to a system comprising a central electronic computing device designed to carry out a method according to the first aspect of the invention.

Advantageous embodiments and refinements as well as advantages of the first aspect of the invention are to be considered advantageous embodiments and refinements as well as advantages of the second aspect of the invention and vice versa here.

Further features of the invention result from the claims, the figures, and the description of the figures. The features and combinations of features mentioned above in the description and the features and combinations of features mentioned hereinafter in the description of the figures and/or shown solely in the figures are usable not only in the respective specified combination, but also in other combinations or alone.

### BRIEF DESCRIPTION OF THE DRAWINGS

The invention will now be explained in more detail on the basis of a preferred exemplary embodiment and with reference to the drawings. In the figures:

FIG. 1 shows a schematic view of a traffic region which is passable by autonomous vehicles which have a respective area requirement;

FIG. 2 shows a further schematic view of the traffic region;

FIG. 3 shows a schematic view of a second traffic region;

FIG. 4 shows a schematic view of a third traffic region;

FIG. 5 shows a schematic view of a fourth traffic region; and

FIG. 6 shows a further schematic view of a fifth traffic region.

In the figures, identical or functionally identical elements are provided with identical reference signs.

### DETAILED DESCRIPTION OF THE DRAWINGS

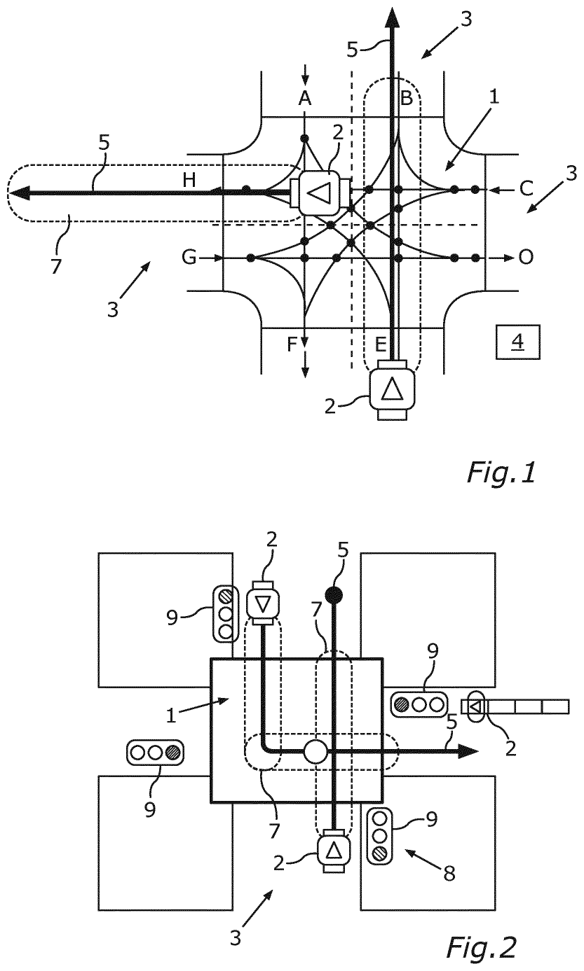

FIG. 1 shows a schematic top view of a traffic region 1, which represents an intersection in which two autonomously driving vehicles 2 are located. The traffic region 1 is formed here as a central area of an intersection, to which surrounding regions 3 are adjacent. The letters A to H mark entry locations or exit locations in the traffic region 1. The arrows show planned or plannable and in particular permitted trajectories 5 of the respective vehicle 2. Furthermore, the lines 6 show possible permitted traversal rules or trajectories through the traffic region 1.

The traffic region 1 in the example shown is thus an intersection of a two-lane road. The first of the autonomous vehicles 2 is designed, for example, as a smart transport robot (abbreviated STR) and the second of the autonomous vehicles 2 is designed as a tugger train, due to which, for example, 800 possible combinations result for driving through the traffic region 1. In order that efficient coordination and therefore a high traffic throughput is possible through the traffic region 1 shown in FIG. 1, a method for coordinating autonomous vehicles 2 in or at the at least one traffic region 1 is presented hereinafter. The method comprises multiple steps:

In a first step, a first trajectory 5 planned by the first of the autonomous vehicles 2 is received by means of a central electronic computing device 4, by which more or less a registration of the first autonomous vehicle 2 with the central electronic computing device 4 takes place. Analogously thereto, in a second step, a second trajectory 5 planned by the second of the autonomous vehicles 2 is received by means of the central electronic computing device 4, by which the second autonomous vehicle 2 also registers with the electronic computing device 4. In a third step, a first area requirement 7 of the first autonomous vehicle 2 along its first planned trajectory 5 is determined and a second area requirement 7 of the second autonomous vehicle 2 along its second planned trajectory 5 is determined, in each case by the central electronic computing device 4. In a fourth step, if it is ascertained by means of the central computing device 4 that the two area requirements 7 at least partially overlap with the planned trajectories 5 in the at least one traffic region 1, the first autonomous vehicle 2 or the second autonomous vehicle 2 is prioritized by the central electronic computing device 4. As a result of the prioritization, an approval is granted, for example, by means of a signal to travel, i.e. to drive into or drive through, the traffic region 1 or through the traffic region 1 for the prioritized autonomous vehicle 2. A chronological interruption of the trajectory 5 of the nonapproved vehicle 2 thus results due to the approval which has not occurred for this vehicle 2.

FIG. 2 shows a schematic top view of the intersection according to FIG. 1, wherein it is now shown schematically simplified. It is shown here that the area requirement 7 due to the trajectory 5 of the vehicle 2 coming from below and the area requirement 7 due to the trajectory 5 of the autonomous vehicle 2 coming from above, which wishes to turn left, would collide.

FIG. 2 shows a traffic signal circuit, which corresponds to a traffic element 8 of the traffic region 1 and which comprises multiple signal lamps or traffic signal lights. The autonomous vehicle 2 coming from the right currently has a red signal as the traffic signal by the traffic signal element 9 and therefore stops.

The prioritization of the autonomous vehicle 2 advantageously takes place on the basis of a specified set of rules stored in the central electronic computing device 4. In the example shown in FIG. 2, the set of rules can be, for example, that the vehicle turning left has to wait. It is now communicated by the method to the vehicle 2, which enables, for example, a separate electronic computing device for control or for effectuating the autonomous driving, by the central electronic computing device 4 that it has to wait in relation to the vehicle 2 coming straight ahead from below.

Each vehicle 2 is to have a fair chance to traverse the traffic region 1, i.e., for example, in an acceptable time. It has to be taken into consideration in dependence between intersections, for example in the case of multiple intersections, that congestion due to incorrect decisions or incorrect prioritizations is to be avoided. Overall, an optimization problem can thus exist, which can advantageously be solved by means of the method.

If the vehicles 2 and the traffic region 1 involved, for example, a production facility of a motor vehicle producer, so that in each case the vehicle 2 coming from above and from below is the STR and the vehicle 2 coming from the right is a tugger train, it can also be stored for the set of rules, for example, that the vehicle 2 which supplies the most important parts for the production is prioritized. Otherwise, simple traffic rules advantageously result for the set of rules, in particular if, for example, it is a traffic region 1 at which the traffic regulations apply. As is made clear by FIG. 2 with the aid of the traffic element 8, the approval can advantageously be carried out by the traffic element 8. Additionally or alternatively, the approval can be carried out by a signal which is transmitted to the prioritized vehicle 2, for example by respective communication devices of the vehicle-intrinsic electronic computing device and the central computing device 4.

It has been shown to be advantageous here that, if it is ascertained by means of the central electronic computing device 4 that the prioritized autonomous vehicle 2 is driven along its planned trajectory 5 such that an overlap of the area requirements 7 does not take place, the central electronic computing device 4 grants an approval to travel the traffic region 1 to the further autonomous vehicle 2.

The traffic region can be designed such that nonautonomous road users also travel it, the traffic is thus hybrid traffic, for example, which is formed from the autonomous vehicles 2 and nonautonomous road users. It can therefore be advantageous if a sensor device of at least one of the autonomous vehicles 2 detects a nonautonomous road user and a correction thus produced of the associated trajectory 5 of the autonomous vehicle 2 is to take place, an update of the prioritization or the approval takes place in or by the central electronic computing device 4.

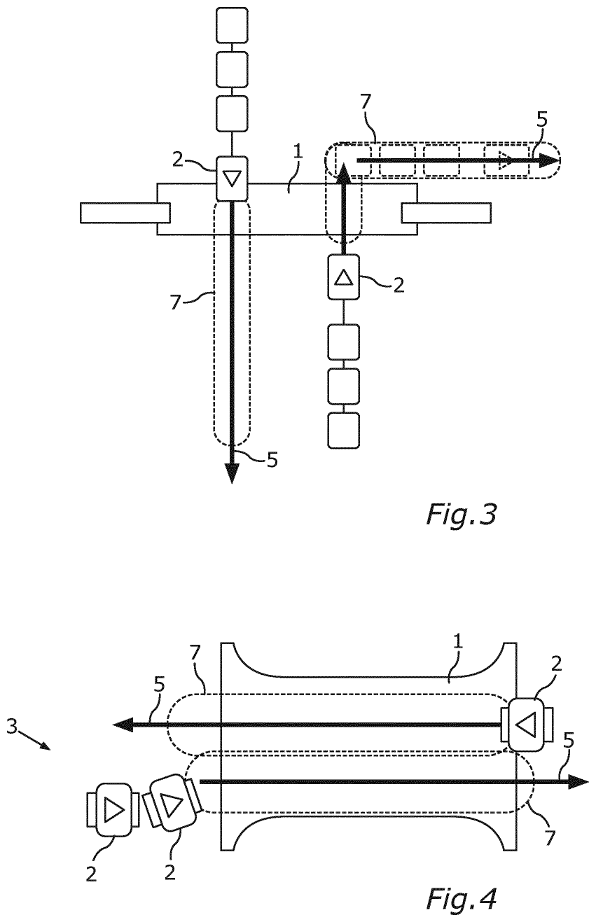

FIG. 3 shows a schematic top view of a traffic region 1, which can be arranged at a fire protection door, for which a set of rules thus applies which states that staying at a standstill in the traffic region 1 is prohibited and in addition it is to be driven through rapidly. It is advantageous here if a status of a traffic element 2, for example of a barrier or the fire protection door, of the traffic region 1 is ascertained and the approval additionally takes place as a function of this ascertained status.

Analogously thereto, FIG. 4 shows a region, also a factory door or the like, for example, which in contrast to a surrounding region 3 is tapered such that the area requirements 7 of oncoming vehicles 2 overlap or intersect. A prioritization therefore also has to take place here. Wherein, as shown in FIG. 4, three vehicles 2 wish to drive into the traffic region 1. It is advantageous here for the method if a further trajectory 5 planned by a further one of the autonomous vehicles 2 is received by means of the central electronic computing device 2, in which the prioritization of one of the previously non-prioritized autonomous vehicles 2 is prioritized on the basis of a time interval. In other words, for example, it is to be enabled solely on the basis of the waiting time of each one of the autonomous vehicles 1 waiting at the traffic region 1 to drive in after a certain time. It is thus possible to avoid a vehicle 2 not being able to be prioritized, for example, due to the remainder of the set of rules.

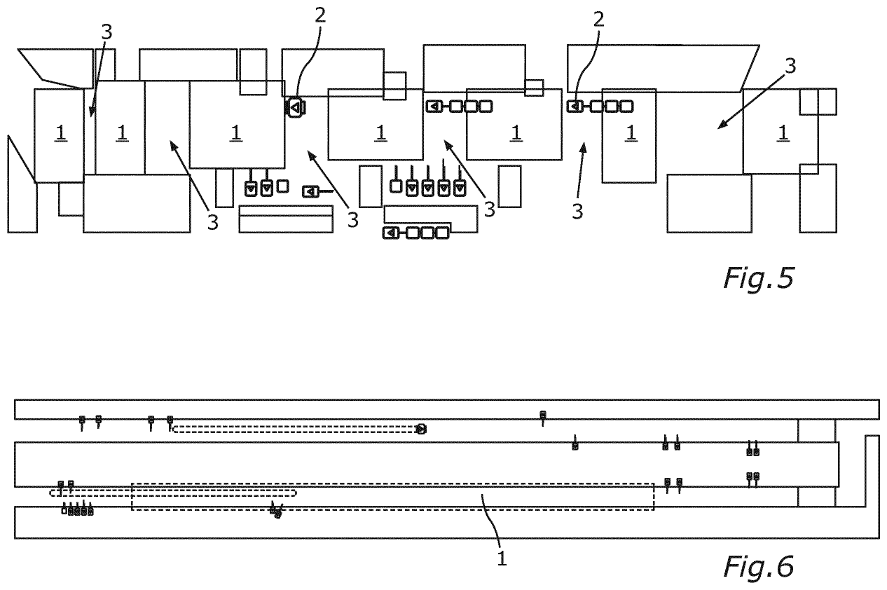

FIG. 5 shows a schematic top view of multiple traffic regions 1 and associated interposed surrounding regions 3, which are arranged, for example, along a production line in the motor vehicle producer. It is therefore advantageous for the method if at least one surrounding region 3, which is adjacent to the at least one traffic region 1 and, in particular in the case of at least two traffic regions 1, lies between the at least two traffic regions 1, is taken into consideration in the approval. If, for example, the surrounding region 3 between two traffic regions 1 is so short that upon an approval the autonomous vehicle 2 driving into the traffic region 1 can no longer leave it, an approval can be omitted or this approval can not take place.

In addition, it is advantageous, if it is ascertained by means of the central electronic computing device 4 that the first trajectory 5 and the second trajectory 5 at least partially coincide in the traffic region 1, but without an overlap of the area requirement 7, if an approval is granted to the first vehicle 2 and to the second vehicle 2, so that, for example, column driving or convoy driving can be enabled, as shown by the two vehicles 2 of FIG. 5 designed as tugger trains.

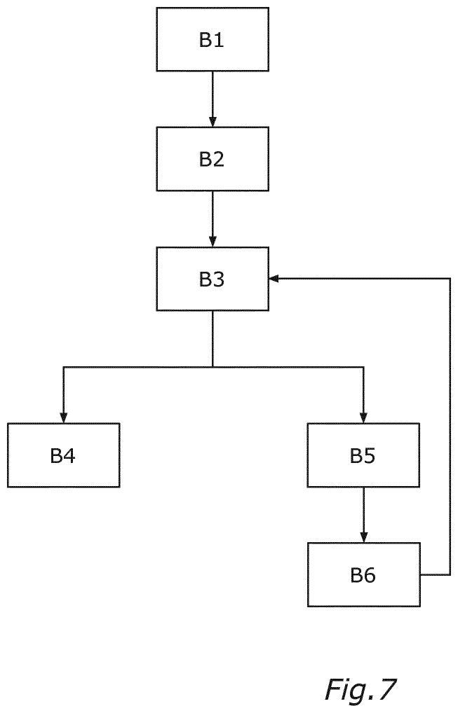

FIG. 6 shows a further traffic region 1, which opens into a cul-de-sac and is narrow, so that it cannot be traveled simultaneously by two oncoming vehicles 2. A corresponding prioritization and approval on the basis of the circumstances, which is to be performed by the electronic computing device 4, is to be observed here. This can be described analogously to the situation shown in FIG. 4 with the addition of the cul-de-sac.

Multiple vehicles 2 can travel the traffic region 1 when there are no conflicts, wherein the limited capacity is to be noted. For example, in convoy situations driving through can be enabled if the respective vehicle 2 drives to a pool outside the zone, for example. It can be ensured by the method that the vehicles 2 leave sufficient space at the edges of the zone or the traffic region 1 so that another vehicle 2 can go around them. For example, overtaking islands or the like can be configured on cul-de-sacs or very long narrow roads, which can be stored as information of the electronic computing device 4 or in the set of rules.

The method explained on the basis of the figures allows it to be ensured, before a vehicle 2 drives into the traffic region 1, that the chance of successful passing of the traffic region 1 is high. In particular, a conflict within the traffic region 1 can be avoided. Furthermore, conflicts upon departing from the zone or the traffic region 1 can be prevented. In the case of multiple traffic regions 1, the utilization as a whole or in particular the utilization of the respective traffic region 1, for example the intersection, can also be as high as possible in particular. The more vehicles 2 drive in parallel over or through the traffic region 1, the more advantageous.

The so-called limited capacity approach has previously been used in the prior art here, which is good from safety aspects, but makes a traffic flow particularly slow. The method presented here represents a significant improvement over this method.

FIG. 7 shows an exemplary schematic sequence of the method. Box B1 represents the request of the vehicle 2 to drive in, box B2 represents conflicts or intersections of the area requirements 7 in the traffic region 1. Box B3 outputs whether there is a conflict. In box B4, the prioritization takes place and the approval takes place in box B5, wherein a continuous check takes place in box B7.

The central electronic computing device 4 can be used to control barriers, fire protection doors, and the like. A time frame, in which attempts are made to use the traffic region 1 as efficiently as possible, can be defined based on the status of the respective facility or traffic element 8. The logic of the method, as shown in FIG. 7, allows access to the vehicles 2 until the status or the state of the respective traffic element 8 changes. The time span can be different depending on the device, for example long in the case of fire protection doors or very short, for example, in the case of barriers. A time-based intersection control or traffic control through the traffic region 1 by means of the central electronic computing device 4 supplies a detailed status, which the vehicle 2 or its controller has to observe.

A system is also to be presented on the basis of the figures and the presented method, which comprises the central electronic computing device 4 and which is designed to carry out the method.

The problem is therefore countered both by the presented method and by the presented system, which can occur by means of a regular traffic supervision which cannot enable a high throughput with high safety aspects at a traffic region as in the case of an intersection. A conflict of the preference for route vehicles and smart transport robots is thus possible in the example of vehicle production shown.

It is desirable in production or also in traffic for blockades within the traffic region to be avoided, because the traffic, in particular the manual traffic, is supposed to flow, because fire protection doors have to be able to be closed at any time. Because production facilities continue to run and because high safety requirements have to take place for the approval.

A hybrid intersection control for manual and autonomous traffic is particularly advantageously implementable by the presented method and the presented system.

### List of Reference Signs

1 traffic region
2 vehicle
3 surrounding region
4 central electronic computing device
5 trajectory
6 line
7 area requirement
8 traffic element
9 signal device
B1 box 1
B2 box 2
B3 box 3
B4 box 4
B5 box 5
B6 box 6

1-10. (canceled)

11. A method for coordinating autonomous vehicles in at least one traffic region, the method comprising:
receiving a first trajectory planned by a first of the autonomous vehicles by means of a central electronic computing device;
receiving a second trajectory planned by a second of the autonomous vehicles by means of the central electronic computing device;
determining a first area requirement of the first autonomous vehicle along its first planned trajectory and determining a second area requirement of the second autonomous vehicle along its second planned trajectory;
when it is ascertained by means of the central computing device that the two surface requirements at least partially overlap with the planned trajectories in the at least one traffic region:
prioritizing the first autonomous vehicle or the second autonomous vehicle by way of the central electronic computing device; and
granting approval to travel the traffic region for the prioritized autonomous vehicle.

12. The method according to claim 11, wherein:
the first autonomous vehicle or the second autonomous vehicle is prioritized on the basis of a specified set of rules stored in the central electronic computing device.

13. The method according to claim 11, wherein:
the approval for the travel is carried out by a signal, which is transmitted to at least one of the prioritized vehicle or by a traffic element of the traffic region.

14. The method according to claim 11, further comprising:
when it is ascertained by means of the central electronic computing device that the prioritized autonomous vehicle is driven along its planned trajectory such that an overlap of the area requirements does not take place, the central electronic computing device grants an approval to travel the traffic region to the further autonomous vehicle.

15. The method according to claim 11, wherein:
at least one surrounding region, which is adjacent to the traffic region, is taken into consideration in the approval

16. The method according to claim 11, wherein:
a status of a traffic element of the traffic region is ascertained and the approval further takes place as a function of this ascertained status.

17. The method according to claim 11, wherein:
when a further trajectory planned by a further one of the autonomous vehicles is received by means of the central electronic computing device, in the prioritization, one of the previously non-prioritized autonomous vehicles is prioritized on the basis of a time interval.

18. The method according to claim 11, wherein:
when it is ascertained by means of the central electronic computing device that the first trajectory and the second trajectory at least partially coincide in the traffic region, but without an overlap of the surface requirements, an approval is granted to the first autonomous vehicle and to the second autonomous vehicle.

19. The method according to claim 11, wherein:
when a nonautonomous road user is detected by a sensor device of at least one of the autonomous vehicles and a correction of the associated trajectory of the autonomous vehicle which has detected the road user thus takes place, an update of the prioritization or the approval takes place.

20. A system comprising a central electronic computing device, which is designed to carry out a method according to claim 11.
